(19) United States
(12) Patent Application Publication
(10) Pub. No.: US 2022/0250321 A1
(43) Pub. Date: Aug. 11, 2022

(54) 3D PRINTING DEVICE AND 3D PRINTING METHOD

(71) Applicants: Brose Fahrzeugteile SE & Co. Kommanditgesellschaft, Würzburg, Würzburg (DE); AIM3D GmbH, Rostock (DE)

(72) Inventors: Stefan BEETZ, Barnin (DE); Clemens LIEBERWIRTH, Rostock (DE); Vincent MORRISON, Krakow am See (DE)

(73) Assignees: Brose Fahrzeugteile SE & Co. Kommanditgesellschaft, Würzburg, Würzburg (DE); AIM3D GmbH, Rostock (DE)

(21) Appl. No.: 17/436,460

(22) PCT Filed: Mar. 4, 2020
(86) PCT No.: PCT/EP2020/055688

§ 371 Date: Sep. 3, 2021

(30) Foreign Application Priority Data
Mar. 5, 2019 (DE) 10 2019 202 941.8

(51) Int. Cl. B29C 64/314; B33Y 10/00; B33Y 30/00; B33Y 50/02; B29C 64/118; B33Y 40/10; B29C 64/393; B29B 13/06

(52) U.S. Cl. CPC B29C 64/314; B33Y 10/00; B33Y 30/00; B29B 13/06; B29C 64/118; B33Y 40/10; B29C 64/393; B33Y 50/02

(57) ABSTRACT

A 3D printing device having at least one printing nozzle for applying a print material intended for the manufacture of a component to be printed. In particular, the 3D printing device comprises at least one moisture sensor designed to produce a signal depending on a moisture content of the print material fed in the direction of the at least one printing nozzle.

### CROSS-REFERENCE TO RELATED APPLICATIONS

This application is the U.S. National Phase of PCT Application No. PCT/EP2020/055688 filed on Mar. 4, 2020, which claims priority to German Patent Application No. 10 2019 202 941.8, filed on Mar. 5, 2019, the disclosures of which are hereby incorporated in their entirety by reference herein.

### TECHNICAL FIELD

This application relates to a 3D printing device having at least one printing nozzle for applying a printing material for the production of a component to be printed.

### BACKGROUND

In 3D printing, three-dimensional components are usually built-up layer by layer from one or more materials. Materials used here include, for example, plastics, resins, ceramics and/or metals. For example, in this context, so-called fused deposition modeling (FDM) is known. Here, a component or a workpiece is built up layer by layer from a meltable plastic or a molten material.

For the layer-by-layer production of the respective component, printing material is applied to a printing plate via at least one printing nozzle of a 3D printing device, e.g., in the form of a so-called 3D printer. The respective component is built up layer-by-layer by the printing material emerging from the printing nozzle with the help of a computer.

SUMMARY

According to one embodiment, a 3D printing device is proposed which includes at least one moisture sensor set up to generate an (electronic) signal depending on a moisture content of the printing material conveyed in the direction of the at least one printing nozzle of the 3D printing device.

The quality of the print result for three-dimensionally printed components may depend on the moisture content of the printing material used for printing. By now providing a 3D printing device in which an electronic signal may be generated with the help of at least one moisture sensor and, depending on the sensed moisture content of the printing material, the quality of the print result may be controlled more specifically and, if necessary, also more easily automated.

Possible drying of the printing material may be carried out under electronic control and thus integrated into the process within the framework of a 3D printing method to be implemented with the 3D printing device. Here, too, advantage is taken of the fact that it was recognized that, depending on a moisture content in a printing material for printing three-dimensional components, such plastic material (e.g., PA6), an improvement in the quality of the components to be produced and a binding strength may be significantly increased if a low-moisture content of the inkjet printing material is maintained.

For example, the at least one moisture sensor of the 3D printing device may be set up to generate a signal if the moisture content of the printing material conveyed in the direction of at least one printing nozzle, exceeds a defined threshold value. For example, if a plastic material such as PA6 is used, the moisture sensor may generate a signal if the moisture content of the plastic material is above 0.1%. With a moisture content of ≤0.1%, for example, it may be ensured that vapor bubble formation is largely or even completely excluded during the 3D printing process and thus the three-dimensional component to be printed has a low porosity.

A moisture content of a printing material of which the material moisture is measured is understood as the ratio of the mass of the water contained in the printing material to the mass of the anhydrous printing material.

In one or more embodiments, the 3D printing device includes a conditioning device for adjusting the moisture content of printing material to be conveyed in the direction of at least one printing nozzle. This conditioning device is designed to change the moisture content of the printing material to be conveyed in the direction of at least one printing nozzle in response to the signal generated by at least one moisture sensor. A corresponding conditioning device includes, for example, at least one conditioner, e.g., in the form of a dryer, in order to reduce the moisture content in a targeted manner if necessary and depending on a signal from the moisture sensor, namely by an amount signaled by the moisture sensor. A corresponding 3D printing device may integrate a conditioning device for an automatic adjustment of the moisture content so that the conditioning device may be operated automatically with the help of at least one moisture sensor to provide at least one printing nozzle of the 3D printing device with printing material that has a moisture content below a defined threshold value. The generated (electronic) signal from the moisture sensor may be a control signal to control electronics of a conditioning device.

Alternatively or additionally, the signal generated by the at least one moisture sensor may be processable by an alarm device of the 3D printing device to generate an alarm and/or to generate an entry in an electronic operating log of the 3D printing device. If, for example, a threshold value of the moisture content is exceeded by a printing material conveyed to the printing nozzle, the moisture sensor responds and transmits a corresponding (alarm) signal to the alarm device. This alarm device then generates, for example, an optical and/or acoustic signal to indicate a possibly critical moisture content of the currently used printing material. Alternatively or additionally, for the purpose of quality assurance, it is possible to log that and in the context of which process, such as at what time, the processed printing material had a moisture content exceeding a threshold value.

Another aspect of this disclosure relates to a 3D printing device including a conditioning device for adjusting the moisture content of printing material to be conveyed in the direction of at least one printing nozzle of the 3D printing device. The conditioning device is connected via at least one material line to the printing nozzle, that is to say, for example, a printhead having the printing nozzle, in order to convey conditioned printing material from the conditioning device to the printing nozzle.

In the 3D printing device proposed according to another aspect, there is at least one material line, by which the conditioning device for providing printing material of which the moisture content has been conditioned is connected to the at least one printing nozzle of the 3D printing device. Thus, conditioned printing material may be conveyed to the printing nozzle under electronic control and therefore possibly automatically. For example, in this way, printing material dried to an appropriately low moisture content may be conveyed to the printing nozzle under electronic control.

This embodiment, therefore, consequently provides no manual charging of a 3D printing device with previously separately conditioned printing material. Instead, an appropriate conditioning device is already integrated into the proposed 3D printing device, so that the conditioning device may be supplied with raw material in order to convey conditioned printing material in the direction of the at least one printing nozzle automatically and in accordance with stored specifications.

A 3D printing device having a conditioning device and a material line according to the another aspect may also include at least one moisture sensor in harmony with the previously discussed first aspect of the proposed solution. In this way, for example, depending on the at least one signal from the moisture sensor, the integrated conditioning device of the 3D printing device may be controlled and, via the at least one material line, directly appropriately varied conditioned printing material may be conveyed to the printing nozzle.

In a design variant, the 3D printing device provided with a conditioning device includes at least one fill level sensor, which is set up to generate a signal in response to which additional printing material is conveyed from the conditioning device or into the conditioning device. In response to the (electronic) signal from the at least one fill level sensor, it is thus possible, for example, for printing material from the conditioning device to be conveyed in the direction of the at least one printing nozzle and here also, if appropriate, into an intermediate container connected upstream of the printing nozzle. Alternatively or additionally, additional printing material may be conveyed from a raw material reservoir into the conditioning device in response to the electronic signal from the at least one fill level sensor. As a result of the use of at least one fill level sensor, it is thus possible for an inflow, such as a continuous inflow of conditioned and/or unconditioned printing material to be controlled electronically.

According to one or more embodiments, a conditioning device of the 3D printing device includes at least two, possibly even at least three, separate conditioners. The separate conditioners may be provided here, for example, for different types of printing material. If a plurality of conditioners are provided on the 3D printing device, components made of different printing materials conditioned in different conditioners may be used in one or more operations. For example, a design variant provides for three different printing materials to be provided in three separate conditioners of a conditioning device, in order to print a three-dimensional component to be built up from a plurality of printing materials automatically via one or more printing nozzles of the 3D printing device.

Alternatively or additionally, a plurality of conditioners of a conditioning device may also be provided, if needed, to provide a higher conveyed quantity of conditioned printing material in the direction of the printing nozzle. In addition, a 3D printing device may include a plurality of printing nozzles—possibly in different printheads of the 3D printing device—which may be supplied rapidly and variably with conditioned printing material via a plurality of conditioners.

A design variant provides, for example, that a plurality of conditioners may be assigned to exactly one of a plurality of printing nozzles, in order to convey conditioned printing material from the plurality of conditioners to one printing nozzle. Conditioned printing material from one or more conditioners may hereby be conveyed to the at least one printing nozzle, for example as needed and under electronic control. Thus, for example, the 3D printing device may be configured to use only printing material from a first associated conditioner for the printing of a first workpiece, while for the production of a second workpiece of another type or else only a specific section of the first workpiece, the printing nozzle is supplied with printing material from another conditioner or more than one conditioner in order to take account of an increased building rate, for example during the layer-by-layer build-up of the three-dimensional workpiece. The ability to assign different conditioners to one or more printing nozzles of the 3D printing device may be switched variably here, such as electronically.

As an example, at least one of a plurality of separate conditioners of a conditioning device may also be kept as a reserve, which delivers printing material in the direction of one or more printing nozzles of the 3D printing device only if a malfunction of another conditioner is to be feared or has occurred and/or additional printing material is needed in a mounting cycle.

Likewise, provision may be made for a conditioner or at least two conditioners to be assignable to a plurality of printing nozzles in order to convey conditioned printing material from the one conditioner optionally or simultaneously to a plurality of printing nozzles. An appropriate conditioner may permit higher flexibility in the components to be fabricated with the 3D printing device and the printing materials and printing nozzles that may be used for this purpose, without having to convert the 3D printing device laboriously.

Each conditioner of a conditioning device may be assigned to exactly one of a plurality of printing nozzles (on one or more printheads) of the 3D printing device.

In a design variant, the 3D printing device includes at least one raw material reservoir, which is connected to a conditioning device of the 3D printing device and by which printing material may additionally be conveyed automatically into the conditioning device for conditioning. Here, the 3D printing device consequently includes at least one (raw material) conveying device for the automated conveyance of printing material (possibly unconditioned) to the conditioning device. Here, a corresponding (raw material) conveying device may be provided in addition to a conveying device for the automatic conveyance of conditioned printing material from the conditioning device to one or more printing nozzles of the 3D printing device. A conveying device (for unconditioned or conditioned printing material) may include a screw conveyor, for example.

A further aspect of the proposed solution relates to a 3D printing method, in which, by using at least one printing nozzle, printing material provided for the production of a component to be printed is applied (e.g., on a printing platform). Here, it is proposed to use sensors to determine a moisture content of the printing material conveyed in the direction of the at least one printing nozzle and, with the aid of a conditioning device, to change the moisture content of the printing material to be conveyed in the direction of the at least one printing nozzle, depending on the moisture content determined.

Consequently, one aspect of the proposed 3D printing method is to perform conditioning of a printing material automatically, depending on the moisture content, in order to provide printing material having a moisture content not exceeding a threshold value to at least one printing nozzle of a 3D printing device under electronic and sensor control.

Design variants of a proposed 3D printing method may be implemented here by design variants of a proposed 3D printing device. Advantages and features of a 3D printing device explained above and below thus also apply to design variants of a proposed 3D printing method and vice versa.

### BRIEF DESCRIPTION OF THE DRAWINGS

FIG. 1 schematically shows the structure of a design variant of a proposed 3D printing device with the aid of which a design variant of a proposed 3D printing method may be implemented.

FIG. 2 schematically shows the interaction of different components in a design variant of a proposed 3D printing device.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

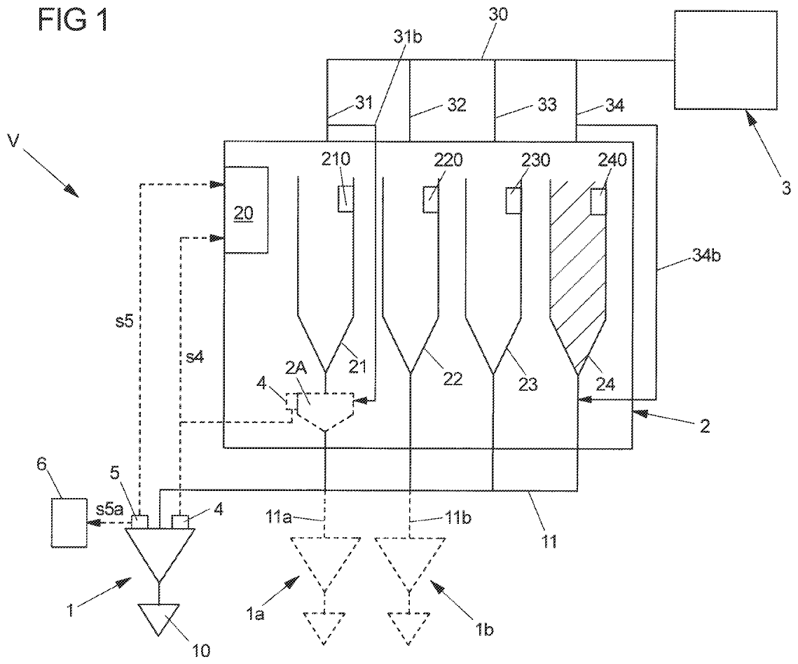

FIG. 1 shows an example embodiment of a 3D printing device V. The 3D printing device V has a printhead 1, which may include a plurality of printheads 1a, 1b. The printhead 1 is configured to supply printing material for the printing of a three-dimensional component, e.g., applied layer-by-layer on a printing platform. To discharge the printing material, a printhead 1, 1a, 1b in each case has at least one printing nozzle 10. For example, the 3D printing device is set up and provided for the performance of fused deposition modelling (FDM for short).

In the illustrated embodiment, the 3D printing device V has the printhead 1 coupled to a conditioning device 2, via which specifically conditioned printing material may be conveyed to the printhead 1 (or else to one of the further printheads 1a or 1b). For the (motor-assisted) conveyance, for example a conveying device not illustrated in FIG. 1 is provided. Such a conveying device includes a screw conveyor, for example. The printing material to be conditioned in the conditioning device 2, e.g., dried, may include, for example, a plastic material, such as for example PA6, and/or be present in the form of granules.

The printhead 1 of the 3D printing device V is, for example, connected via a (main) feed line 11 to the conditioning device 2 so that printing material conditioned by the conditioning device 2 may be conveyed to the printhead 1 and its printing nozzle 10. Printing material from the conditioning device 2 is fed to the optionally additionally provided printheads 1a, lb via separate feed lines 11a, 11b. The 3D printing device V illustrated thus integrates a conditioning device 2, with which printing material to be used may be specifically conditioned, e.g., dried. The printing material may be dried to a predefined moisture content within the 3D printing device V and therefore integrated in the process.

For the automatic control of the conditioning device 2 and at least one conditioner, e.g., dryer(s) 21-24 of the conditioning device 2, the conditioning device 2 has control electronics 20. These control electronics 20 may receive a (control) signal s5 from a moisture sensor 5 of the 3D printing device V. This signal s5 is generated by the moisture sensor 5 if the conditioned printing material conveyed from the conditioning device 2 to the printhead 1 has a moisture content above a predefined threshold value. Depending on the signal s5 from the moisture sensor 5, with the aid of the control electronics 20 of the conditioning device 2, at least one dryer 21-24 of the conditioning device 2 is then activated in order to change a dryness of the printing material prepared therein. In this way, in response to the signal s5 from the moisture sensor 5, the moisture content of the printing material provided by the conditioning device 2 may be changed, e.g., automatically.

However, a signal generated by the moisture sensor 5 may also alternatively or additionally, for example, be transmitted as an (alarm) signal s5a to an alarm/logging device 6 of the 3D printing device V. If, with the aid of the moisture sensor 5, it is determined that conditioned printing material conveyed to the printhead 1 exceeds a stored threshold value for the moisture content, it is thus possible via the alarm/logging device for a visually and/or optically perceivable alarm signal and/or an entry in an electronic operating log of the 3D printing device V to be generated. Via an appropriate alarm signal s5A, for example, in such a way a user of the 3D printing device V may be informed about possible faulty charging of the printing nozzle 10 with printing material. Furthermore, in the course of quality assurance, via an electronic operating log it is possible to recheck the extent to which a three-dimensionally printed component was possibly at least partly printed with printing material, the moisture content of which had exceeded the stored threshold value.

In the design variant illustrated, the moisture sensor 5 is provided by way of example on the printhead 1. However, this is of course not imperative. The moisture sensor 5 and/or an additional moisture sensor may, for example, also be provided in the feed line 11.

As shown in FIG. 1, the conditioning device 2 has a plurality of conditioners 21-24 such as at least 3. For conditioning via these different conditioners, here in the form of dryers 21-24, different types of printing materials, such as printing materials that differ from one another with regard to their moisture content to be adjusted or the type of material, may be conditioned and conveyed to a printhead 1, 1a and/or 1b as needed. Thus, the flexibility of the 3D printing device V and the number of components to be produced hereby without extensive conversion may be increased considerably via a plurality of conditioners 21-24 integrated in the 3D printing device V.

A dryer 24 of the conditioning device 2 may otherwise also be kept as a reserve, for example, in order to intercept a possibly increased throughput of printing material and/or to compensate for the malfunction of another dryer 21, 22 or 23.

Provision may be made for a conditioner/dryer 21 of the conditioning device 2 to convey conditioned printing material into an intermediate container 2A, from which the conditioned printing material is conveyed to the one printhead 1 and/or the further printheads 1a, 1b via the feed line 11.

A fill level sensor 4, for example, may be provided on this intermediate container 2A. If a fill level in the intermediate container 2A falls below a defined fill level threshold value, a (fill level) signal s4 is transmitted to the control electronics 20 of the conditioning device 2. In response to this signal s4, printing material may then be conveyed in the direction of the intermediate container 2A, for example from the conditioner/dryer 21. Alternatively, new or additional charging of the conditioner/dryer 21 connected upstream of the intermediate container 2A may then be signaled.

In the FIG. 1 example, a fill level sensor 4 may alternatively or additionally be provided on the printhead 1 if there is a printhead reservoir for printing material to be kept for the printing nozzle 10 on the printhead 2. If the printing material kept in the printhead 1 falls below a fill level threshold value, it is also possible here for new printing material from the conditioning device 2 to be conveyed electronically via a (fill level) signal s4.

The 3D printing device V may additionally have a raw material reservoir 3. From this raw material reservoir 3, printing material may be conveyed via a conveying line 30 and corresponding feed lines 31-34 to the conditioners 21-24 of the conditioning device 2. For example, an adequate fill level of the conditioners 21-24 of the conditioning device 2 with unconditioned printing material may be ensured electronically and at least partly automatically, and therefore in turn an adequate flow of conditioned printing material to a printing nozzle 10 of one or more printheads 1, 1a, 1b may be ensured.

In order also to be able, if necessary, to supply raw material which needs no separate drying, one or more bypass lines may be provided. Via such a bypass line which, in FIG. 1, is illustrated by way of example as a bypass line 3 lb, 34b to the feed line 31 or 34, raw material from the raw material reservoir 3 may be led past the conditioners 21-24 to a printhead 1, la, lb.

In order always to ensure an adequate fill level in a conditioner 21-24 of the conditioning device 2, each conditioner 21-24 is equipped with a fill level sensor 210, 220, 230 or 240. In response to a (fill level) signal from a fill level sensor 210, 220, 230 or 240, raw material may automatically be conveyed electronically from the raw material reservoir 3.

With the 3D printing device V illustrated and for example the conditioning device 2 integrated herein and the at least one moisture sensor 5, a printing nozzle 10 of the 3D printing device V may not only be charged flexibly with different printing materials and differently conditioned printing materials. Rather, more extensive automation of a 3D printing process may also be achieved hereby in that, for example, control logic is provided in order to control a conditioning process for the printing material to be conveyed to the nozzle 10 by using a (control) signal s5 from the moisture sensor 5.

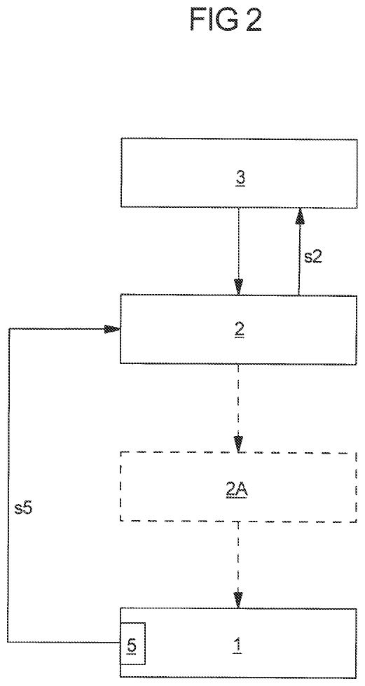

By using FIG. 2, basic effective relationships within a 3D printing device V from FIG. 1 are illustrated once more by way of example.

Here, by using arrows, firstly material flows from the raw material reservoir 3 to the conditioning device 2 and, if appropriate via the optional intermediate container 2A, from the conditioning device 2 to a printhead 1 are sketched. Secondly, by using further arrows, possible control signals s2 and s5 from the conditioning device 2 or the moisture sensor 5 may be seen. Here, the conditioning device 2 may request the conveyance of raw material or unconditioned printing material from the raw material reservoir 2 to the conditioning device 2 via a control signal s2 on the conditioner side. In addition, via the control signal s5 from the moisture sensor 5, the conditioning of the printing material to be conveyed to the printhead 1 may be influenced by the printhead 1 in order to ensure a moisture level of the printing material below a stored threshold value for the further processing at the printing nozzle 10 of the printhead 1.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### LIST OF DESIGNATIONS

1, 1a, 1b Printhead

10 Printing nozzle

11 (Main) feed line

11a, 1b Feed line

2 Conditioning device

20 Control electronics

21, 22, 23, 24 Dryer/conditioners

210, 220, 230, 240 Fill level sensor

2A Intermediate container

3 Raw material reservoir

30 Conveying line

31, 32, 33, 34 Feed line

31, 31b, 34b Bypass line

4 Fill level sensor

5 Moisture sensor

6 Alarm/logging device

S2, s4, s5, s5a Signal

V 3D printing device

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A 3D printing device, comprising:
at least one printing nozzle configured to apply a printing material for production of a component; and
at least one moisture sensor configured to generate a signal depending on a moisture content of the printing material conveyed in a direction of the at least one printing nozzle.

2. The 3D printing device as claimed in claim 1, wherein the at least one moisture sensor generates the signal when the moisture content of the printing material conveyed in the direction of the at least one printing nozzle exceeds a threshold value.

3. The 3D printing device as claimed in claim 1, further comprising a conditioning device configured to adjust the moisture content of the printing material to be conveyed in the direction of the at least one printing nozzle, wherein the conditioning device is activated, in response to the signal being generated by the at least one moisture sensor, to change the moisture content of the printing material to be conveyed in the direction of the at least one printing nozzle.

4. The 3D printing device as claimed in claim 1 further comprising an alarm device configured to receive the signal generated by the at least one moisture sensor and to generate an alarm or an entry in an electronic operating log of the 3D printing device.

5. The 3D printing device as claimed in claim 1 further comprising:
a conditioning device configured to adjust the moisture content of the printing material to be conveyed in the direction of the at least one printing nozzle; and
at least one material line connecting between the conditioning device and the at least one printing nozzle (10).

6. The 3D printing device as claimed in claim 5 further comprising at least one fill level sensor configured to generate a signal in response to which additional printing material is conveyed from the conditioning device or into the conditioning device.

7. The 3D printing device as claimed in claim 3, wherein the conditioning device includes at least two separate conditioners.

8. The 3D printing device as claimed in claim 7, wherein the separate conditioners are associated with different types of the printing material.

9. The 3D printing device as claimed in claim 1, wherein the at least one printing nozzle is at least two printing nozzles.

10. The 3D printing device as claimed in claim 9 further comprising a conditioning device configured to adjust the moisture content of the printing material to be conveyed in the direction of the at least one printing nozzle, wherein the conditioning device includes at least two separate conditioners, and wherein select ones of the conditioners are assigned to exactly one of the printing nozzles in order to convey conditioned printing material from the select ones of the conditioners to the one of the printing nozzles.

11. The 3D printing device as claimed in claim 10, wherein another of the conditioners is assigned to a plurality of the printing nozzles in order to convey conditioned printing material from the another conditioner simultaneously to the plurality of printing nozzles.

12. The 3D printing device as claimed in claim 3 further comprising at least one raw material reservoir that is connected to the conditioning device and configured to automatically convey the printing material to the conditioning device for conditioning.

13. A 3D printing method comprising:
supplying a printing material, for production of a component to be printed, to at least one printing nozzle;
determining, via a sensor, a moisture content of the printing material;
generating a signal from the sensor depending on the moisture content determined; and
responsive to the signal, changing the moisture content of a portion of the printing material to be conveyed in a direction of the at least one printing nozzle with a conditioning device.

14. The method as claimed in claim 13 further comprising:
generating the signal responsive to the moisture content exceeding a threshold.

15. The method as claimed in claim 14 further comprising:
drying the portion of the printing material with the conditioning device responsive to the signal being generated.

16. The method as claimed in claim 13 further comprising:
drying the portion of the printing material with the conditioning device.

17. The method as claimed in claim 13 further comprising:
activating an alarm device in response to the signal being generated.

18. A 3D printing comprising:
at least one printing nozzle (10) configured to apply a printing material;
at least one moisture sensor configured to sense a moisture content of a portion of the printing material conveyed in a direction of the at least one printing nozzle and to generate a signal responsive to the moisture content exceeding a threshold;
a conditioning device configured to dry the portion of the printing material; and
control electronics configured to receive the signal and programmed to command the conditioning device to dry the portion responsive to the signal being received.

19. The 3D printing device as claimed in claim 18, wherein the conditioning device includes at least one dryer.

20. The 3D printing device as claimed in claim 18 further comprising an alarm device, and wherein the control electronics is further programmed to active the alarm device responsive to the signal being received.
